(19) United States
(12) Patent Application Publication
(10) Pub. No.: US 2007/0222194 A1
(43) Pub. Date: Sep. 27, 2007

(54) Air bag module with a shield

(75) Inventors: Jeffery A. Harvey, Sterling Heights, MI (US); Rickey L. Stratton, Pontiac, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems inc.

(21) Appl. No.: 11/386,488

(22) Filed: Mar. 22, 2006

(51) Int. Cl. B60R 21/26

(52) U.S. Cl. 280/740; 280/736; 280/742

(57) ABSTRACT

An apparatus (10) for helping to protect a vehicle occupant in a vehicle collision includes an inflatable vehicle occupant protection device (12), an inflator (14) for providing inflation fluid to inflate the inflatable vehicle occupant protection device (12) with the inflator fluid flow from the inflator (14) being transverse to a central axis (16) of the inflator (14), and a shield (70) including a piece (72) of material folded about the inflator (14) and having a wall portion (102) interposed between the inflator (14) and the inflatable vehicle occupant protection device (12) and against which gas initially exiting from the inflator (14) impinges. The wall portion (102) has tear seams (76a-d) that rupture due to inflation fluid pressure acting on the shield (70) to enable the wall (102) portion to form a plurality of flaps (80a-d) within the inflatable occupant protection device (12).

### TECHNICAL FIELD

The present invention relates to an apparatus for helping to protect a vehicle occupant in a vehicle collision.

### BACKGROUND OF THE INVENTION

Many vehicles have an air bag that inflates to help protect a vehicle occupant when the vehicle is involved in a collision. The air bag is inflated by inflation fluid provided by an air bag inflator. Certain air bag inflators produce inflation fluid by combustion of a pyrotechnic material. Combustion products in the inflation fluid may be hot, and might cause damage to the material of the air bag.

Known retainers, which retain the air bag to an air bag module, have deflectors to help direct hot inflation gas away from the air bag. As an alternative, U.S. Pat. No. 6,336,659 shows an air bag module with a shield for protecting an air bag from hot inflation fluid.

### SUMMARY OF THE INVENTION

The present invention relates to an apparatus for helping to protect a vehicle occupant in a collision. The apparatus includes an inflatable vehicle occupant protection device and an inflator for providing inflation fluid to inflate the inflatable vehicle occupant protection device. The inflation fluid flow from the inflator is transverse to a central axis of the inflator. The apparatus further includes a shield. The shield includes a piece of material folded about the inflator and having a wall portion, which is interposed between the inflator and the inflatable vehicle occupant protection device and against which gas initially exiting from the inflator impinges. The wall portion has a plurality of tear seams that rupture due to inflation fluid pressure acting on the shield to enable the wall portion to form a plurality of flaps within the inflatable vehicle occupant protection device. Each flap pivots away from the central axis of the inflator about a pivot axis which extends in a direction transverse to the central axis of the inflator to block inflation fluid contact with portions of the inflatable vehicle occupant protection device.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a sectional view of an air bag module constructed in accordance with a first embodiment of the present invention;

FIG. 2 is a view similar to FIG. 1 showing the air bag module during inflation of the air bag;

FIG. 3 is a schematic plan view of a panel used to form a shield of the first embodiment of the present invention;

FIG. 4 is a bottom perspective view of the shield of the first embodiment of the present invention in a folded state and associated with an air bag retaining ring;

FIG. 5 is a schematic plan view of a panel used to form a shield according to a second embodiment of the present invention; and

FIG. 6 is a bottom perspective view of the shield of the second embodiment of the present invention in a folded state and fastened to an air bag retaining ring.

### DETAILED DESCRIPTION OF THE INVENTION

The present invention relates to an apparatus which includes an inflatable vehicle occupant protection device, such as an air bag. Other inflatable vehicle occupant protection devices that can be used in accordance with the invention include, for example, inflatable seat belts, inflatable knee bolsters, inflatable head liners, inflatable side curtains, and knee bolsters operated by inflatable air bags.

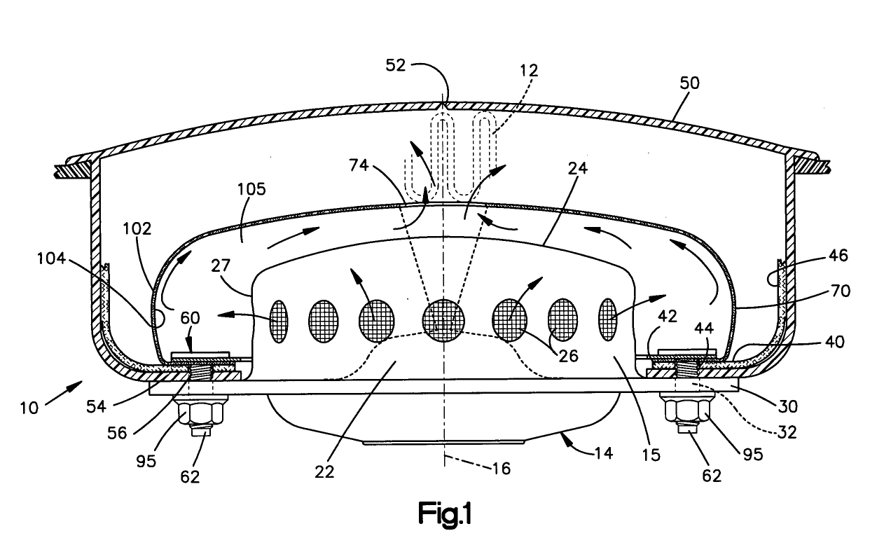

An apparatus 10 in accordance with a first embodiment of the present invention is shown in FIG. 1. The apparatus 10 includes an air bag 12 and an inflator 14 to inflate the air bag 12. The inflator 14 contains an ignitable gas generating material, which, when ignited, produces a volume of inflation fluid in the form of a gas to inflate the air bag 12. Alternatively, the inflator 14 could contain a stored quantity of pressurized inflation fluid, or could contain a combination of pressurized inflation fluid and ignitable material for heating the pressurized inflation fluid.

The inflator 14 has a central axis 16 and includes cylindrical housing 15. The housing 15 includes a circular upper end wall 24 and an axially extending cylindrical side wall 27. The upper end wall 24 of the housing 15 is domed, that is, has a curved configuration projecting upward (as viewed in the drawings) and inward from the side wall 27. A circumferentially spaced plurality of outlet openings 26 are formed in the side wall 27 of the housing 15 for directing inflation gas out of the inflator 14 in directions extending transverse to the central axis 16.

A mounting flange 30 projects radially outward from a lower end (as viewed in FIG. 1) of the inflator 14. The mounting flange 30 has four circumferentially spaced apart fastener openings 32. Lead wires (not shown) extend from the lower end of the inflator 14 and are electrically connected with electrical circuitry and with a vehicle deceleration sensor for actuating the inflator, as known in the art.

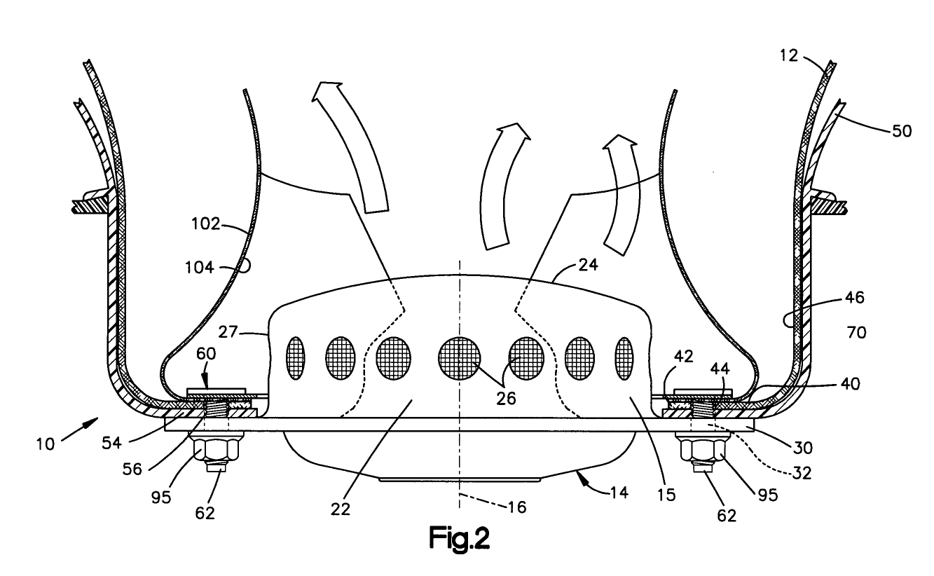

The air bag 12 is made from a fabric material, such as woven nylon. The air bag 12 includes a mouth portion 40, which includes a central opening 42 through which the housing 15 of the inflator 14 extends. Four circumferentially spaced openings 44 are provided in the mouth portion 40 of the air bag 12 and are aligned with the fastener openings 32 of the mounting flange 30. Parts of the main body portion 46 of the air bag 12 are omitted for clarity in FIGS. 1 and 2.

The apparatus 10 also includes a cover 50, which covers the folded air bag 12 and the inflator 14. The cover 50 has a rupturable tear seam 52, which is preferably not visible in the vehicle when the apparatus 10 is mounted in the vehicle. The cover 50 also has a mounting portion 54, which extends radially inward toward the axis 16 at a location between the air bag mouth portion 40 and the inflator mounting flange 30. The mounting portion 54 includes four circumferentially spaced fastener apertures 56.

The apparatus 10 further includes a bag retaining ring 60, which has a circular ring shaped inner portion 63 and a square shaped outer flange portion 61 (FIG. 4). The inner portion 63 is recessed with respect to the outer flange portion 61. The bag retaining ring 60 includes a central opening 92. The bag retaining ring 60 circumscribes the inflator 14. The retaining ring 60 is made of plastic or any other suitable material. Four steel mounting studs 62 are insert molded on the outer flange portion 61 of the plastic retaining ring 60.

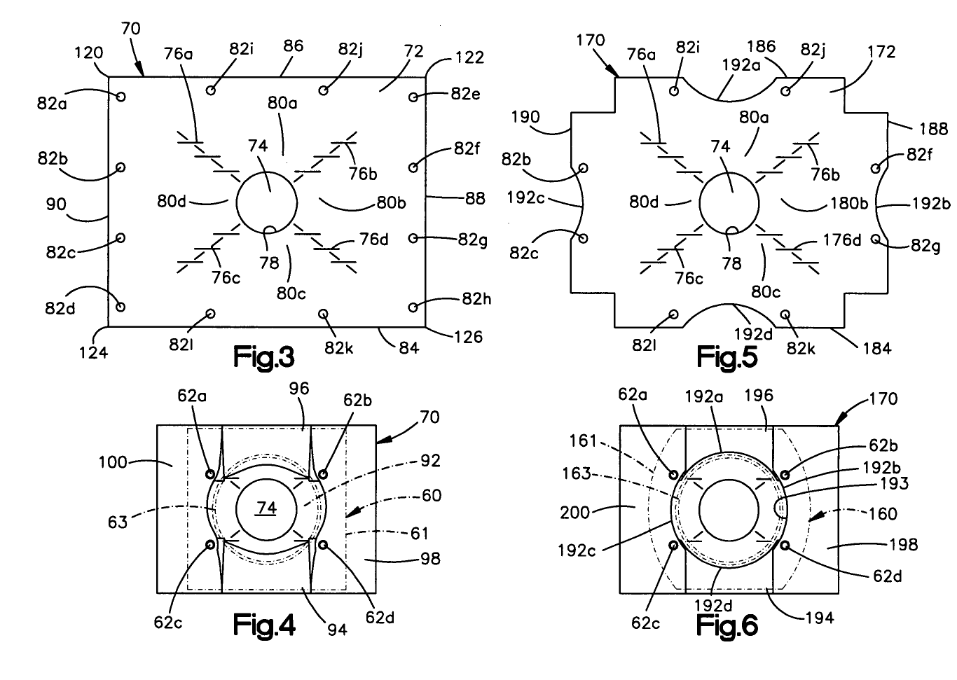

The apparatus 10 further includes a heat shield 70. As best seen in FIG. 3, the heat shield 70 is constructed from a piece 72 of fabric material that is rectangular in shape. The fabric piece 72 is made of nylon 840 denier thread. The fabric piece 72 includes a circular opening 74 that is centrally located in the fabric piece 72. The opening 74 is defined by an edge 78 of the fabric piece 72. The fabric piece 72 further comprises four tear seams 76a-d located equally spaced around the central opening 74.

A first tear seam 76a begins from a location near the edge 78 of the fabric piece 72 and extends away from the opening 74 in a direction towards a rear left corner 120 of the fabric piece 70 as viewed in FIG. 3. A second tear seam 76b begins from a location near the edge 78 of the fabric piece 72 and extends away from the opening 74 in a direction towards a rear right corner 122 of the fabric piece 72. A third tear seam 76c begins from a location near the edge 78 of the fabric piece 72 opposite the second tear seam 76b and extends away from the opening 74 in a direction towards a front left corner 124 of the fabric piece 72. A fourth tear seam 76d begins from a location near the edge 78 of the fabric piece 72 opposite the first tear seam 76a and extends away from the opening 74 in a direction towards a front right corner 126 of the fabric piece 72.

The first and fourth tear seams 76a, 76d are located on a diagonal line extending between the rear left corner 120 and front right corner 126 of the fabric piece 72. The second and third seams 76b, 76c are located on a diagonal line extending between the rear right corner 122 and front left corner 124 of the fabric piece 72. Triangular inner flaps 80a-d of the fabric piece 72 are formed between adjacent tear seams 76a-d. All of the tear seams 76a-d are of equal length. When the tear seams rupture, the inner flaps 80a, 80b, 80c, 80d are allowed to pivot along their respective axes 210, 212, 214, 216. In particular, inner flap 80a is located between tear seams 76a and 76b and can pivot about axis 210. Inner flap 80b is located between tear seams 76b and 76d and can pivot about axis 212. Inner flap 80c is located between tear seams 76c and 76d and can pivot about axis 214. Inner flap 80d is located between tear seams 76a and 76c and can pivot about axis 216. Each of the axes 210, 212, 214, 216 extend in a direction transverse to the central axis 16 of the inflator 14.

A plurality of fastener apertures 82 are provided in the fabric piece 72 near the periphery of the fabric piece 72. The fabric piece 72 has front and rear edges 84, 86, and right and left side edges 88, 90. Four apertures 82a-d are located near the left side edge 90 and are each spaced the same distance from the left side edge 90. The distances between adjacent apertures 82a-d are also equal to one another. Four apertures 82e-h are located near the right side edge 88 and are each spaced the same distance from the right side edge 88. The distances between the adjacent apertures 82e-h are also equal to one another.

Two apertures 82i, 82j are located near the rear edge 86 and are each spaced the same distance from the rear edge 86. Two apertures 82k, 82l are located near the front edge 84 and are each spaced the same distance from the front edge 84.

As seen in FIG. 4, the fabric piece 72 is fastened to the bag retaining ring 60. The central opening 74 of the fabric piece 72 is centered over the inflator 14 and the central opening 92 in the bag retaining ring 60. The central axis 16 of the inflator 14 extends through the central opening 74. The edges 84, 86, 88, 90 of the fabric piece 72 are folded over onto the fabric piece 72 to form respective folded over portions 94, 96, 98, 100, and each folded over portion is secured to adjacent folded over portions. In particular, edges 84 and 86 are first folded over onto the fabric piece 72 to form respective folded over portions 94 and 96. Then, edges 88 and 90 are folded over on the fabric piece 72 to form respective folded over portions 98 and 100. Fold over portion 94 is secured to the front corners of fold over portions 98 and 100, fold over portion 96 is secured to the rear corners of fold over portions 98 and 100, fold over portion 98 is secured to the right corners of fold over portions 94 and 96, fold over portion 100 is secured to the left corners of fold over portions 94 and 96.

The folded over portions 94, 96, 98, 100 are clamped between the mouth portion 40 of the air bag 12 and the bag retaining ring 60. When in this position, fabric piece 72 forms the heat shield 70 for the air bag 12. During the assembling of the apparatus 10, the fabric piece 72 and retaining ring 60 are assembled as a unit as seen in FIG. 4. The studs 62 projecting from the retaining ring 60 extend through the apertures 82 of the folded portions 94, 96, 98, 100. Specifically, a rear left stud 62a extends through the left aperture 82i of the rear edge 86 and the rear apertures 82a, 82b of the left side edge 90. A rear right stud 62b extends through the right aperture 82j of the rear edge 86 and the rear apertures 82e, 82f of the right side edge 88. A front left stud 62c extends through the left aperture 82l of the front edge 84 and the front apertures 82c, 82d of the left side edge 90, and a front right stud 62d extends through the right aperture 82k of the front edge 84 and the front apertures 82g, 82h of the right side edge 88.

The studs 62a-d also extend through the openings 44 of the mouth portion 40 of the air bag 12, the respective apertures 56 in the mounting portion 54 of the cover 50, and fastener openings 32 in the mounting flange 30 of the inflator 14. Nuts 95 screwed onto the studs 62a-d clamp the mouth portion 40 of the air bag 12 between the retaining ring 60 and inflator mounting flange 30 and secure the heat shield 70, the inflator 14, and the air bag 12 in the apparatus 10.

The housing 15 of the inflator extends through the mounting portion 54 of the cover 50 and through the central opening 42 in the mouth portion of the air bag 12. The tear seams 76a-d are spaced apart around the end wall 24 of the housing 15 of the inflator 14. As seen in FIG. 1, the heat shield 70 includes a wall portion 102 that is interposed between the inflator 14 and the air bag 12 and against which gas exiting from the outlets 26 of the inflator 14 initially impinges. The wall portion 102 includes the tears seams 76a-76d and flaps 80a-80d.

Silicone material is coated on an inner surface 104 of the wall portion 102 facing the inflator 14. The wall portion 102 extends over the inflator 14 and covers the inflation outlets 26. The wall portion 102 is spaced outwardly from the inflator to define a chamber 105 between the inner surface 104 and outer side surface 22 of the housing 15 of the inflator 14 as shown in FIG. 1. The central opening 74 of the heat shield 70 is spaced upwardly adjacent from the upper end wall 24 of the inflator 14. The central opening 74 has a diameter that is smaller than the diameter of the upper end wall 24. Because of this configuration of the inflator 14 and heat shield 70, the inflation gas from the inflator 14 enters the chamber 105 at a faster flow rate than the gas exits the chamber 105 through the central opening 74. As a result, pressure builds up in the chamber 105 until the pressure causes the tear seams 76a-d to rupture.

The vehicle in which the apparatus 10 is mounted includes known electrical means (not shown) for sensing an impact to the vehicle and for actuating the inflator 14 in response to the sensing of an impact. The electrical means may, for example, include a deceleration sensor and vehicle circuitry for electrically actuating the inflator 14 in response to sensing vehicle deceleration greater than a predetermined threshold value for which inflation of the air bag 12 is desired to help protect the vehicle occupant. The electrical means is electrically connected with the inflator 14 for providing an actuation signal to the inflator 14.

In operation, when the inflator 14 is actuated, inflation gas, as indicated by the arrows in FIG. 1, flows out of the inflator 14 through the inflation fluid outlets 26 in the outer side surface 22 of the housing 15 of the inflator 14. The inflation fluid flow from the inflator 14 is transverse to the central axis 16 of the inflator. The inflation gas flows into the chamber 105 and then impinges on the inner surface 104 of the wall portion 102 of the heat shield 70, which diverts the gas away from the air bag 12. The wall portion 102 directs the inflation gas to flow into the air bag 12 through the central opening 74 of the heat shield 70, which reduces the flow rate of the gas.

The difference between the gas flow rate into the chamber 105 and the gas flow rate out of the chamber 105 causes the pressure in the heat shield 70 to increase. The pressure increase and the gas flow against the seams 76a-d cause the seams to rupture or tear, and the triangular flaps 80a, 80b, 80c, 80d to pivot about their respective axes 210, 212, 214, 216 away from the inflator 14 at a predetermined time, e.g., about 5 milliseconds or less, after actuation of the inflator 14.

As more inflation gas flows from the inflation fluid outlets 26, the inner flaps 80a, 80b, 80c, 80d pivot about their respective axes 110, 112, 114, 116 away from the upper end wall 24 and central axis 16 of the inflator 14 to a position shown in FIG. 2, which allows more inflation gas to flow out of the deflector shield 70 to inflate the air bag 12 faster than when the seams 76a-d are not torn. The flaps 80a-d block inflation fluid contact with portions of the air bag 12. As a result, hot particles that may be present in the flow of inflation gas from the inflator 14 tend to contact the shield 70 instead of the air bag 12.

FIGS. 5 and 6 show a heat shield 170 and bag retainer 160 of a second embodiment of the present invention. The reference numbers for the elements of the first embodiment are used for similar elements in the second. Elements that are different are given different reference numbers. In the second embodiment, the fabric piece 172 is cross-shaped with the edges 184, 186, 188, 190 having arcuate cut outs 192a-d. As depicted in FIG. 6, the cut outs 192a-d together define a circular opening 193 when the edges of the fabric piece 172 are folded over to form the folded portions 194, 196, 198, 200. The circular opening 193 is sized to fit around the cylindrical side wall 27 of the inflator 12.

In this embodiment, the apertures 82i, 82j are located at opposite ends of the cut out portion 192a of the rear edge 186. The apertures 82f, 82g are located at opposite ends of the cut out portion 192b of the right side edge 188. The apertures 82l, 82k are located at opposite ends of the cut out portion 192d of the front edge 184. The apertures 82b, 82c are located at opposite ends of the cut out portion 192c of the left side edge 190. Adjacent apertures in different edges are aligned with each other when the edges 184, 186, 188, 190 are folded over to form the folded portions 194, 196, 198, 200 as seen in FIG. 6. In particular, apertures 82b and 82i are aligned with each other, apertures 82j and 82f are aligned with each other, apertures 82g and 82k are aligned with each other, and apertures 82l and 82c are aligned with each other when the edges 184, 186, 188, 190 are folded over to form the folded portions 194, 196, 198, 200.

The bag retaining ring 160 includes a circular inner lip portion 163 and a barrel shaped flange portion 161. The inner lip portion 163 extends upwardly from the flange portion 161. The bag retaining ring 160 circumscribes the inflator 14. The retaining ring 160 is made of plastic or any other suitable material. The four steel mounting studs 62 are insert molded on the outer flange portion 161 of the retaining ring 160. The other elements and their operation in this second embodiment is the same as that of the first embodiment.

From the above description of the invention, those skilled in the art will perceive improvements, changes and modifications. For example, the apparatus 10 may not include a bag retaining ring. Such improvements, changes and modifications within the skill of the art are intended to be covered by the appended claims.

1. An apparatus for helping to protect a vehicle occupant in a vehicle collision, said apparatus comprising:
an inflatable vehicle occupant protection device;
an inflator for providing inflation fluid to inflate said inflatable vehicle occupant protection device, the inflation fluid flow from said inflator being transverse to a central axis of said inflator; and
a shield comprising a piece of material folded about said inflator and having a wall portion which is interposed between said inflator and said inflatable vehicle occupant protection device and against which inflation fluid initially exiting from said inflator impinges;
said wall portion having a plurality of tear seams that rupture due to inflation fluid pressure acting on said shield to enable said wall portion to form a plurality of flaps within said inflatable vehicle occupant protection device, each flap pivoting away from said central axis of said inflator about a respective pivot axis which extends in a direction transverse to said central axis of said inflator to block inflation fluid contact with portions of said inflatable vehicle occupant protection device.

2. An apparatus as defined in claim 1, wherein said shield comprises an opening located in said piece of material, said inflator having an end adjacent said opening, said central axis of said inflator extending through said opening, and said inflation fluid initially exiting from said inflator is diverted by said shield through said opening into said inflatable vehicle occupant protection device.

3. An apparatus as defined in claim 2, wherein said tear seams are four in number and are located equally spaced around said opening, and four flaps are formed when said tear seams rupture.

4. An apparatus as defined in claim 1, wherein said piece of material has its opposite edges folded over onto the piece of material and each folded over portion is secured to the adjacent folded over portions.

5. An apparatus as defined in claim 4 including a plurality of fasteners that extend through said inflatable vehicle occupant protection device and said folded over portions to secure said shield and said inflatable vehicle occupant protection device in said apparatus.

6. An apparatus as defined in claim 1 wherein said inflator includes an end wall and a cylindrical side wall, said shield being interposed between said inflatable vehicle occupant protection device and said end wall and said side wall.

7. An apparatus as defined in claim 6 wherein said tear seams of said shield are spaced apart around said end wall of said inflator.

8. An apparatus for helping to protect a vehicle occupant, said apparatus comprising:
an inflatable vehicle occupant protection device;
an inflator for providing inflation fluid to inflate said inflatable vehicle occupant protection device, the inflation fluid flow from said inflator being transverse to a central axis of said inflator; and
a shield comprising a wall portion interposed between said inflator and said inflatable vehicle occupant protection device and against which inflation fluid initially exiting from said inflator impinges, said wall portion comprising an opening aligned with said central axis of said inflator;
said wall portion comprising a plurality of flap portions interconnected by a plurality of tear seams, said tear seams being rupturable in response to inflation fluid acting on said shield to release said flaps, said flaps when released being pivotable away from said central axis of said inflator to block inflation fluid contact with portions of said inflatable vehicle occupant protection device.

9. An apparatus as defined in claim 8, wherein said opening is configured to be centered on said central axis upon initial deployment of said inflatable vehicle occupant protection device is deployed.

10. An apparatus as defined in claim 8, wherein said opening has a generally circular configuration and is centered on said central axis upon initial deployment of said inflatable vehicle occupant protection device.

11. An apparatus as defined in claim 8, wherein inflation fluid initially exiting from said inflator is diverted by said shield through said opening into said inflatable vehicle occupant protection device.
